(19) United States
(12) Patent Application Publication
(10) Pub. No.: US 2009/0279650 A1
(43) Pub. Date: Nov. 12, 2009

(54) METHOD AND APPARATUS FOR GENERATING CLOCK SIGNALS FOR QUADRATURE SAMPLING

(75) Inventor: Xuecheng Qian, Shanghai (CN)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 12/299,570

(22) PCT Filed: Mar. 2, 2007
(86) PCT No.: PCT/IB07/50684

§ 371 Date: Nov. 4, 2008

(30) Foreign Application Priority Data
Mar. 3, 2006 (CN) 200610059415.1
Mar. 2, 2007 (IB) PCT/IB2007/050684

(51) Int. Cl. H04L 7/00

(52) U.S. Cl. 375/355

(57) ABSTRACT

The present invention provides a quadrature-sampling clock signals generation method and apparatus for use in a receiver The apparatus firstly obtains an initial clock signal whose frequency is lower than twice of the carrier frequency of an input signal, then divides the frequency of the initial clock signal by two to obtain two quadrature intermediate clock signals, and finally divides the frequency of the two intermediate clock signals respectively to output two quadrature sampling clock signals. With the clock signal generation method and apparatus of the present invention, it is possible to operate a VCO at a relative low frequency, which will not only reduce the cost of the VCO, but also decrease the power consumption thereof.

### FIELD OF THE INVENTION

The present invention relates to a receiver for use in the field of wireless communication, and more particularly, to a clock signals generation method and apparatus for use in the quadrature sampling receiver.

### BACKGROUND ART OF THE INVENTION

In a conventional wireless communication receiver, the RF signals received from antenna are generally subjected to a series of processing to become baseband or low intermediate frequency signals in advance, before they are converted into digital signals. Furthermore, the received RF analog signals usually pass through a series of filters so as to filter the out-of-band interference and suppress noises. The configuration of such kind of receiver has good performance, and imposes simple requirement on each functional module since the interference is filtered in a stage-by-stage manner during signal processing. At the same time, however, this kind of receiver brings high cost due to the low integration level of elements.

Recently, another kind of receiver configuration has drawn great attention in the art. Such kind of receiver makes use of RF-Sampling technique, where the signal received from antenna is sampled directly after limited filtering and amplification in the RF band, and then the sampled signal is processed in discrete domain, so that it is possible to use more advanced techniques for discrete signal processing. This kind of receiver dispenses with many analog circuits, and therefore is more flexible in circuit design and more suitable for multi-mode communications. In addition, during the manufacturing, the analog and digital circuits thereof may use the same semiconductor process, so that a high integration level and low cost can be achieved.

FIG. 1 shows the configuration of an RF sampling receiver which adopts quadrature sampling technique, wherein the RF signal received from antenna is sampled respectively in two paths in order to be converted into discrete domain, after it has been processed by an RF filter 10 and a low noise amplifier 20. Both of the sampling frequencies fₛ in these two paths are 1/N of carrier frequency f_{c} of the RF signal, but there is a fixed relative delay c between the two sampling clock signals CLK₁, CLK₂, such that the phases of carriers at the sampling point of the clock signals in these two paths are different with each other by 90°. In discrete domain, the out-of-band interference and noises in the sampled signals are suppressed by discrete filters 31,32 respectively. The sampled signals are then converted into digital signals by analog-digital converters 41,42 respectively. Finally, they are sent into digital signal processing unit 60 for baseband signal processing via digital filters 51,52.

The receiver configuration shown in FIG. 1 is more attractive due to its relative low sampling frequency. However, this kind of receiver is required to provide two clock signals with a phase shift of 90°, in order that the RF signals may be sampled respectively. In practice, these two clock signals are normally obtained by an apparatus for generating clock signals shown in FIG. 2. The frequency of initial clock signal from voltage controlled oscillator (VCO, not shown) is 2 f_{c}. The initial clock signal is divided into two intermediate clock signals with the same frequency of f_{c} but with a phase shift of 90° via a ½ divider 700. Subsequently, these two intermediate clock signals pass through two 1/N dividers 701, 702 respectively, to ultimately obtain two sampling clock signals required by the receiver, that is, two sampling clock signals having frequency of fₛ=f_{c}/N.

A disadvantage of the above solution is that it is required to generate an initial clock signal with high frequency. Taking a Bluetooth system as an example, the carrier frequency f_{c} thereof is around 2.4 GHz. Consequently, a VCO is required to be able to generate an initial clock signal with frequency of 2 f_{c}, i.e., around 4.8 GHz. However, a VCO operating at such a high frequency is not only expensive, but also has a much higher power consumption, therefore, it is not economical for a receiver to utilize such kind of VCO.

### SUMMARY OF THE INVENTION

One of the objects of the present invention is to provide a method and apparatus for generating clock signals for quadrature sampling for use in a receiver, which method and apparatus utilize an initial clock signal with relative low frequency, so that the cost and power consumption of VCO is reduced.

A method for generating clock signals for quadrature sampling for use in a receiver according to the present invention comprises the steps of:

obtaining an initial clock signal whose frequency is lower than a predetermined multiple of carrier frequency of an input signal;

dividing the frequency of said initial clock signal by two, to obtain two quadrature intermediate clock signals; and

dividing the frequency of said two intermediate clock signals respectively, to output two quadrature sampling clock signals.

An apparatus for generating clock signals for quadrature sampling for use in a receiver according to the present invention comprises:

an initial clock signal generator, for generating an initial clock signal whose frequency is lower than a predetermined multiple of carrier frequency of an input signal;

a first frequency divider, for receiving said initial clock signal and dividing the frequency thereof by two, to obtain two quadrature intermediate clock signals; and

two second frequency divider, for receiving said two intermediate clock signals respectively and dividing the frequency thereof, to output two quadrature sampling clock signals.

In addition, in the above method and apparatus for generating clock signals for quadrature sampling of the present invention, if sampling factor of the receiver for the input signal is N, and the frequencies of said two intermediate clock signals are divided by α, the frequency of said initial clock signal will be 1/p of twice of the carrier frequency of input signal, where p is an odd number and satisfies that pα=N.

Since the frequency of initial clock signal used by the method and apparatus for generating clock signals for quadrature sampling proposed by the invention is only 1/p of the frequency required in the conventional clock signal generation apparatus. Accordingly, with the method and apparatus for generating clock signals of the present invention, it is possible to operate a VCO at a relative low frequency, which may not only reduce the cost of the VCO, but also decrease the power consumption thereof.

Other objects and attainments together with a fuller understanding of the invention will become apparent and appreciated by referring to the following descriptions and claims taken in conjunction with the accompanying drawings.

### BRIEF DESCRIPTION OF THE DRAWINGS

The present invention will be further elaborated by means of the accompanying drawings and specific embodiments, in which:

FIG. 1 is a block diagram showing the configuration of a quadrature RF sampling receiver.

FIG. 2 is a block diagram showing the configuration of a conventional clock signal generation apparatus for quadrature sampling.

FIG. 3 is a block diagram showing a general configuration of a clock signal generation apparatus for quadrature sampling of the invention.

FIG. 4 is a block diagram showing a simplified configuration of the clock signal generation apparatus for quadrature sampling of the invention.

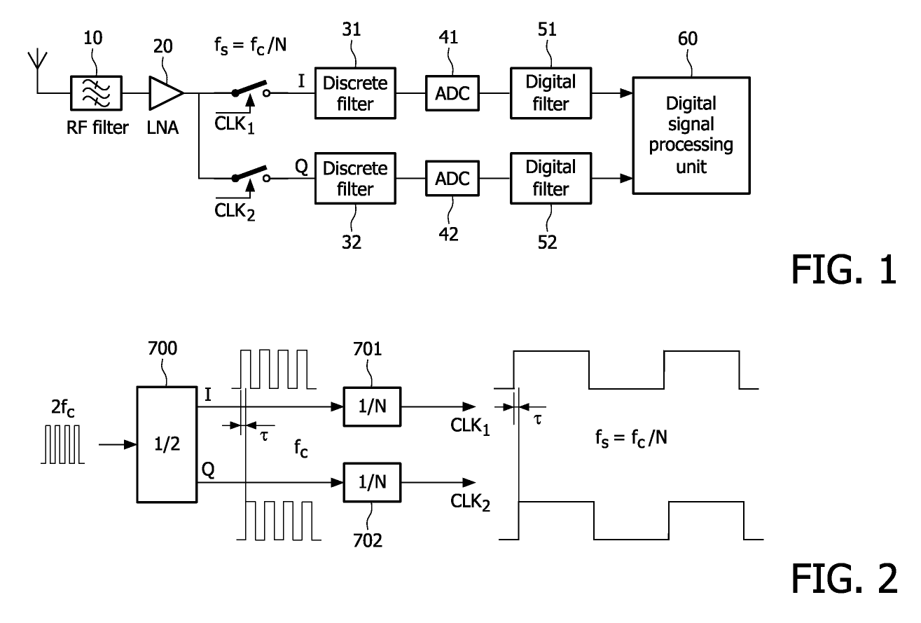

Throughout the drawings, same reference numerals denote similar or corresponding features or functions.

### DETAILED DESCRIPTION OF THE INVENTION

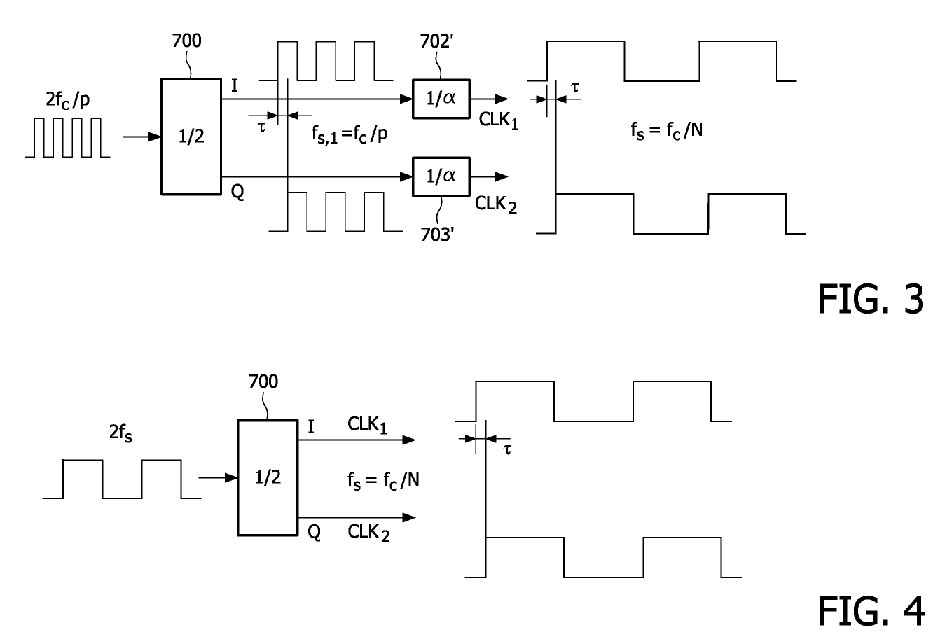

For a quadrature sampling receiver, it is required to provide two clock signals with a phase shift of 90° so as to perform quadrature sampling on received RF signals respectively. In order to reduce the frequency of the initial clock signal of the conventional clock signal generation apparatus shown in FIG. 2, while ensuring that the two clock signals obtained by dividing the frequency of the initial clock signal maintain the phase shift of 90° at carrier frequency, the present invention proposes a new solution to generate clock signals, which will be described in detail in conjunction with FIG. 3.

In a quadrature sampling receiver, if carrier frequency of signal is f_{c} and the subsampling factor is N, the sampling frequency will be

$${f}_{c} = \frac{{f}_{s}}{N} .$$

Since N is an integer, N can be expressed as product of two numbers, i.e. N=αp, where p is the largest odd number, and p≦N, α is an integer.

FIG. 3 is a block diagram showing a general configuration of a clock signal generation apparatus for quadrature sampling of the invention. The frequency of an initial clock signal is 2f_{c}/p, which the initial clock signal are divided into two intermediate clock signals with the same frequency of f_{s,1}=f_{c}/p via a ½ divider 700. Subsequently, these two intermediate clock signals pass through two 1/α dividers 703 and 704 respectively, to ultimately become two sampling clock signals having frequency of fₛ=f_{c}/αp=f_{c}/N.

The time shift between the above two intermediate clock signals is

$$τ = \frac{90 °}{360 °} {T}_{s , 1} = \frac{{T}_{s , 1}}{4} = \frac{{pT}_{c}}{4} , where {T}_{s , 1} = \frac{1}{{f}_{s , 1}} and {T}_{c} = \frac{1}{{f}_{c}} .$$

After the frequencies of these two intermediate clock signals are divided by the two 1/α dividers 703 and 704 respectively, they decrease but the time shift between these two intermediate clock signals remains unchanged. Therefore, the time shift between the resultant two sampling clock signals with the frequency of fₛ=f_{c}/αp=f_{c}/N is also τ. The time shift of τ is equivalent to a phase shift of

$$\frac{{pT}_{c} / 4}{{T}_{c}} 360 ° = p 90 °$$

at the carrier frequency.

Since p is odd number and can be expressed as p=4m±1, where m is an integer, the above phase shift p90°=m(360°)±90°. Thus it can be seen that the two clock signals outputted from the clock signal generation apparatus in FIG. 3 have a phase shift of m(360°)±90°, which meets the requirement of quadrature sampling. For the quadrature sampling receiver, as long as the time shift τ satisfies τ<<1/B, where B is bandwidth of the RF signal, the impact of the time shift on the receiver performance is negligible.

The frequency of the initial clock signal required by the clock signal generation apparatus of the present invention shown in FIG. 3 is only 2f_{c}/p, which is 1/p of the frequency of the initial clock signal required by the conventional clock signal generation apparatus shown in FIG. 2. Taking a Bluetooth system as an example, the system carrier frequency thereof is around 2.4 GHz, and the conventional clock signal generation apparatus requires that a VCO be capable of generating initial clock signal of around 4.8 GHz. However, for the clock signal generation apparatus of the present invention, when the subsampling factor N is 12, 13 and 14 respectively and the p is 3, 13 and 7 respectively, the corresponding frequency of the initial clock signal will be around 0.8 GHz, 0. 185 GHz and 0.343 GHz respectively, which is much lower than the conventionally required 4.8 GHz. Therefore, with the clock signal generation method and apparatus of the present invention, it is possible to operate a VCO at a relative low frequency, which will not only reduce the cost of the VCO, but also decrease the power consumption thereof.

Furthermore, in certain cases, such as when N is an odd number, p=N, the clock signal generation apparatus in FIG. 3 can be simplified to the configuration shown in FIG. 4, wherein the usage of the two 1/α dividers 703 and 704 is eliminated, which further reduces the cost and the power consumption. Therefore, while designing the receiver, it is preferred that N is an odd number such that a better effect would be achieved by the invention, on the other hand, the extreme case that N is an integer power of 2 should be avoided, because this case would not bring forth the advantages of the present invention.

The above embodiment mainly aims at a zero IF (intermediate frequency) quadrature-sampling receiver, that is, fₛ=f_{c}/N. It is apparent that the clock signal generation method and apparatus proposed in the present invention can not only be applied to the zero IF quadrature-sampling receiver, but also be applied to other similar quadrature-sampling receivers, regardless of performing quadrature sampling on IF signals or on RF signals. For example, in the low IF quadrature-sampling receiver, fₛ=(f_{c}±f_{IF})/N, the N can be expressed as product of two numbers as well, i.e. N=αp, where p is the largest odd number, and p≦N, α is an integer. Thereafter, the quadrature sampling clock signal required by the receiver is obtained by utilizing the clock signal generation method and apparatus of the present invention.

It should be appreciated by the skilled persons in the art that many modifications can be made with respect to the clock signal generation method and apparatus disclosed by the above invention, without departing from the contents of the present invention. Therefore, the scope of the present invention should be defined by the content of the appended claims.

1. A quadrature sampling clock signal generation method for use in a receiver, comprising the steps of:
obtaining an initial clock signal whose frequency is lower than a predetermined multiple of carrier frequency of an input signal;
dividing the frequency of said initial clock signal by two, to obtain two quadrature intermediate clock signals; and
dividing the frequency of said two intermediate clock signals respectively, to output two quadrature sampling clock signals.

2. The method according to claim 1, wherein if a sampling factor of the receiver for the input signal is N, and the frequencies of said two intermediate clock signals are divided by α, the frequency of said initial clock signal is 1/p of the predetermined multiple of the carrier frequency of the input signal, where p is an odd number and pα=N.

3. The method according to claim 1, wherein said predetermined multiple is twice.

4. The method according to claim 3, wherein p is the largest odd number obtainable for a determined sampling factor N.

5. A quadrature sampling clock signal generation apparatus for use in a receiver, comprising:
an initial clock signal generator for generating an initial clock signal whose frequency is lower than a predetermined multiple of carrier frequency of an input signal;
a first frequency divider for receiving said initial clock signal and dividing the frequency thereof by two, to obtain two quadrature intermediate clock signals; and
two second frequency divider for receiving said two intermediate clock signals respectively and dividing the frequency thereof, to output two quadrature sampling clock signals.

6. The apparatus according to claim 5, wherein if a sampling factor of the receiver for the input signal is N, and the frequencies of said two intermediate clock signals are divided by α by the first frequency divider, the frequency of the initial clock signal generated by the initial clock signal generator is 1/p of the predetermined multiple of the carrier frequency of the input signal, where p is an odd number and satisfies pα=N.

7. The apparatus according to claim 5, wherein said predetermined multiple is twice.

8. The apparatus according to claim 7, wherein p is the largest odd number obtainable for a determined sampling factor N.

9. A receiver, comprising:
a sampling device for performing quadrature sampling on received signal; and
a clock signal generator for providing a sampling clock signal for the sampling device, comprising:
an initial clock signal generator for generating an initial clock signal whose frequency is lower than a predetermined multiple of carrier frequency of an input signal;
a first frequency divider, for receiving said initial clock signal and dividing the frequency thereof by two, to obtain two quadrature intermediate clock signals; and
two second frequency divider, for receiving said two intermediate clock signals respectively and dividing the frequency thereof, to output two quadrature sampling clock signals.

10. The receiver according to claim 9, wherein if a sampling factor of the sampling device is N, and the frequencies of said two intermediate clock signals are divided by α by the first frequency divider, the frequency of the initial clock signal generated by the initial clock signal generator is 1/p of the predetermined multiple of the carrier frequency of the input signal, where p is an odd number and pα=N.

11. The receiver according to claim 9, wherein said predetermined multiple is twice.

12. The receiver according to claim 11, wherein p is the largest odd number obtainable for a determined sampling factor N.
